(19) United States
(12) Patent Application Publication
(10) Pub. No.: US 2007/0001520 A1
(43) Pub. Date: Jan. 4, 2007

(54) LINEAR MOTOR

(76) Inventors: Tsunehiko YAMAZAKI, Aichi pref. (JP); Naoomi Miyakawa, Aichi pref. (JP)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 11/419,534

(22) Filed: May 22, 2006

(30) Foreign Application Priority Data
Aug. 25, 2004 (JP) 2004-244875

(51) Int. Cl. H02K 41/00

(52) U.S. Cl. 310/12

(57) ABSTRACT

An apparatus for dust prevention and cooling of inside of a linear motor is provided. A linear motor 100 includes a tube 110 having an upper opening, a guide wall 112, and stators 140 which are mounted to both sides of the guide wall 112. A mover 150 has coils 160 and moves along a track 130 in the tube 110. The tube 110 are provided with flange sections 120, and two magnetic members 170 are fitted in each of the flange sections 120 to attract both sides of a cover of a steel belt 200. Cooled and dried air is supplied from a cleaning air supplying apparatus 300 into a flow path 122 to achieve cooling and dust prevention of the tube.

The present application is based on Japanese patent application No. 2004-244875 filed on Aug. 25, 2004, the entire contents of which are hereby incorporated by reference.

### BACKGROUND OF THE INVENTION

1. Field of the Invention

The present invention relates to a linear motor having a tube cover.

2. Description of the Related Art

For example, a linear motor to be mounted in a machine tool to drive an apparatus includes a tube having an upper opening and stators which are linearly arranged in the tube to linearly drive a mover. The mover is coupled to an apparatus such as a column so that the column is linearly driven.

In such a linear motor, a large amount of heat is generated due to the influence of heat produced by overcurrent or Joule heat generated in electromagnetic coils. In order to prevent any displacement due to the heat, cooling of the tube is required in machine tools.

The stators and the mover generate magnetic fields to which magnetic dust and the like is attached, and this may cause operation failure of the motor.

Japanese Patent Publication No. 2004-72910 (Patent Document 1) discloses an apparatus which has a cover over a tube in which a linear motor is mounted to cool the tube with forced-air.

### BRIEF SUMMARY OF THE INVENTION

Object of the Invention

Inside of the cover over the tube, pressures change as the mover moves. Specifically, the pressure downstream in the moving direction is decreased, which causes outside air to be drawn into the tube.

The present invention provides a device which has a cover with an improved sealing ability relative to a tube and effectively prevents entrance of dust into the tube and effectively cools the tube.

### Summary of the Invention

A linear motor according to the present invention basi cally comprises: a tube having an opening; stators disposed in the tube; a mover arranged opposite the stators; and a cover made of a magnetic material to cover the opening of the tube, and moreover it comprises: a plurality of magnetic members which are provided along opposite side edges of the opening of the tube to attract both sides of the cover; and means to supply cooled clean air into a path formed by the plurality of magnetic members.

The linear motor comprises a cover lifting device mounted to the mover, and means for forming an opening between the magnetic members and the cover as the mover moves to supply the cooled clean air into the tube through the cover lifting device.

The linear motor further comprises means for exhausting the air from the tube at one end of the tube.

A linear motor according to the present invention configured as described above achieves the cooling and dust prevention of the tube in which a mover moves.

### BRIEF DESCRIPTION OF THE DRAWINGS

FIG. 1 is a perspective view to show a laser processing machine to which the present invention is applied;

FIG. 2 is a cross sectional view of a linear motor; and

FIG. 3 is a side view of a linear motor.

### DETAILED DESCRIPTION OF THE PREFERRED EMBODIMENTS

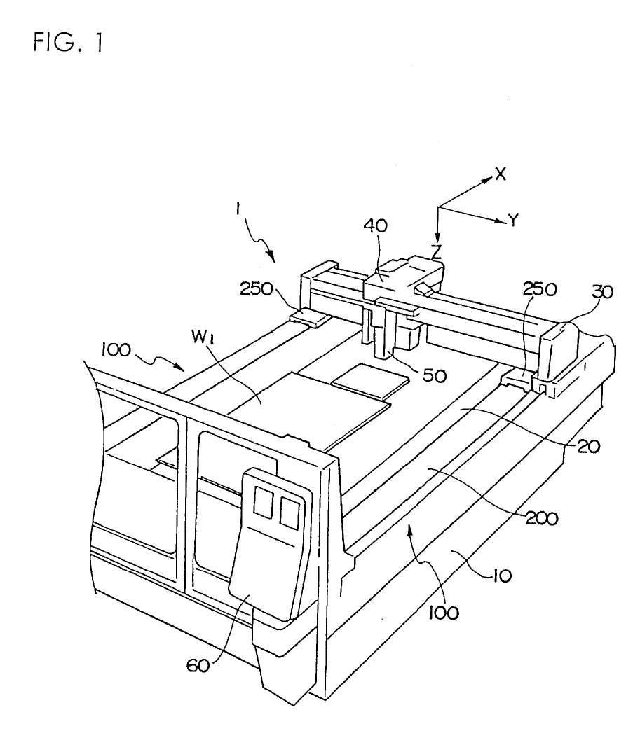

FIG. 1 is a schematic view to show a laser processing machine in which the present invention is implemented, which is denoted by reference numeral 1.

The laser processing machine 1 has a box-shaped frame 10 and a pallet 20 which is provided in the frame 10 to mount a work W₁. The frame 10 has two longitudinal sides to which linear motor devices 100 are mounted respectively.

A column 30 is mounted on the frame 10 for moving in the longitudinal direction of the frame 10, the column 30 being driven and controlled to move in the X axis direction by the linear motor devices 100.

A head unit 40 is attached to the column 30 for moving in the Y axis direction which is perpendicularly crossing the X axis direction. The moving of the head unit 40 is also controlled by the linear motor devices.

A head for laser processing 50 is attached opposite the head unit 40 for moving in the Z axis direction. The moving of the head for laser processing 50 may be also controlled by the linear motor devices 100.

A laser is sent to the head for laser processing 50 from an optical system (not shown) to be focused on a point close to an upper surface of the work W₁ to perform a required laser processing.

A control panel 60 is provided to the frame 10 to control the entire laser processing machine 1.

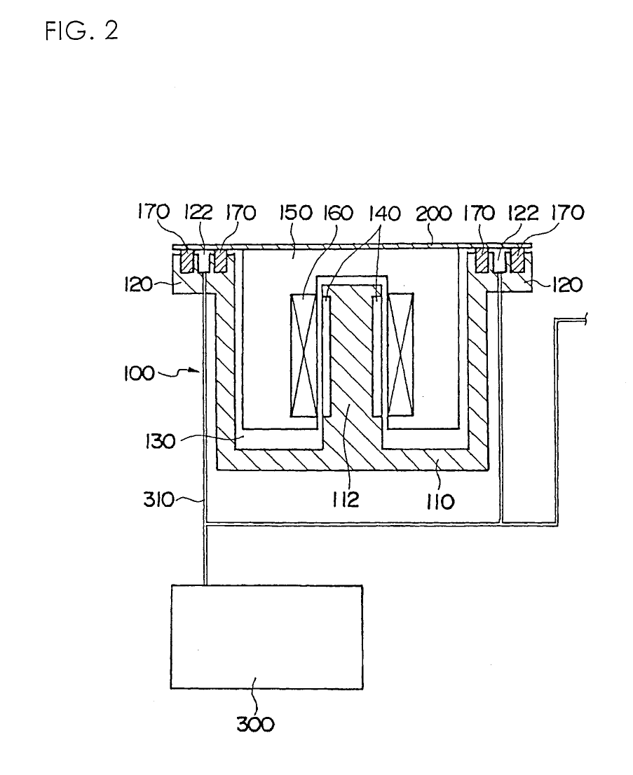

FIG. 2 is a cross sectional view of a linear motor system according to the present invention.

The linear motor device 100 has a tube 110 having an upper opening, and a guide wall 112 which extends upward from the central bottom surface of the tube 110 for mounting stators of the linear motor.

Flange sections 120 are formed along both edges of the upper opening of tube 110.

Tracks 130 are provided in the tube 110 along which a mover of the linear motor runs.

Stators 140 made of permanent magnet are attached to the both sides of the guide wall 112. A mover 150 has coils 160 which are opposing to each stator 140. The stators 140 are constituted of permanent magnets which have alternate surface polarities and are arranged with predetermined spaces therebetween. A power supply to the coils 160 of the mover 150 causes the mover 150 to move in the vertical direction relative to the paper of the drawing to provide a linear motor.

Due to the upper opening of the tube 110, dust and the like in the air enter into the tube 110, which presents a problem that magnetic metal powder is attracted to the stators 140.

To solve the problem, in the present invention, two grooves are formed parallel to the flange sections 120 of the tube 110 to insert and fix two magnetic members 170 in the grooves. The magnetic members 170 are made of magnetic rubber for example. An air flow path 122 runs between the grooves in which the two magnetic members 170 are fitted respectively.

A steel belt 200 is provided under tension over the opening of the tube 110 of the linear motor device 100 along the longitudinal direction of the tube 110. One end of the steel belt 200 is, for example, fixed to the frame, and the other end of the steel belt 200 is fixed via a spring and the like. Thus, the steel belt 200 which is constantly under an appropriate tension functions as a cover over the opening of the tube 110.

Both sides of the steel belt 200 are attracted to the two magnetic members 170 respectively, which provides a sealing mechanism.

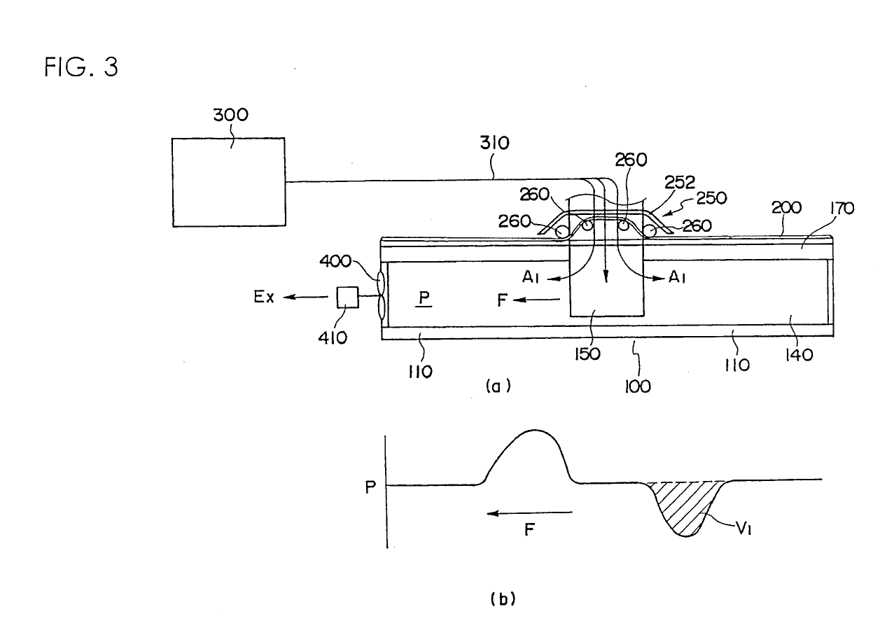

FIG. 3A is a side view of a linear motor device 100.

The stators 140 are disposed in the tube 110, and the mover 150 linearly moves in the direction shown by an arrow F and its opposite direction against the stators 140, and is integrally coupled to the column 30 as a unit. So, when the column moves through, the steel belt 200 should be lifted from the magnetic members 170 to form a gap through which the unit moves.

In the present invention, a steel belt lifting unit 250 is provided on the movers 150. The steel belt lifting unit 250 includes a cover 252 and guide rollers 260 under the cover 252 to lift up and down a part of the steel belt 200 at the position the movers moves through.

During the steel belt 200 is lifted, air is flown into the air flow paths 122 to form an air curtain to prevent the entrance of dirty air outside of the machine into the tube.

A cleaning air source 300 supplies cooled and dried clean air into the air flow paths 122 through piping 310. This maintains the insides of the air flow paths 122 under a positive pressure by the cooled clean air, so that when the steel belt 200 is lifted, an air curtain is formed to prevent the entrance of the outside air into the tube.

As shown in FIG. 3A, the temperature in the tube 110 is increased due to the heat generation of the linear motor. Thus, a fan 400 is provided at one end of the tube 110, which is driven by a motor 410 to exhaust the air inside of the tube.

In order to compensate the exhausted air in the tube, the cooled and dried clean air A₁ from the cleaning air source 300 is forced through the steel belt lifting unit 250 into the tube 110.

This achieves cooling and dust prevention of the tube 110.

As shown in FIG. 3B, when the mover 150 moves in the direction shown by the arrow F in the tube 110, the air pressure P in the tube is increased upstream in the moving direction of the mover 150, and the air pressure P is decreased downstream in the moving direction of the mover 150.

The decreased pressure tends to introduce the outside air into the tube 110, which can be prevented by compensating the amount of air V₁ in the downstream portion at the decreased pressure with the clean air A₁ which is forced into the tube.

In this way, a linear motor having a configuration described above achieves cooling and dust prevention of a tube in which a mover of the linear motor moves through.

What is claimed is:

1. A linear motor, comprising:
a tube having an opening;
a stator disposed in the tube;
movers which are arranged opposite the stator;
a cover made of a magnetic material over the opening of the tube;
a plurality of magnetic members which are provided along opposite side edges of the opening of the tube to attract both sides of the cover; and
means to supply cooled clean air into a path which is formed by the plurality of magnetic members.

2. The linear motor according to claim 1, further comprising a cover lifting device on the mover so that as the mover passes through the tube, an opening is formed between the magnetic members and the cover.

3. The linear motor according to claim 1, further comprising a cover lifting device on the mover, and means to supply the cooled clean air into the tube through the cover lifting device.

4. The linear motor according to claim 1, further comprising means to exhaust air from the tube at one end of the tube.
